(19) United States
(12) Patent Application Publication
(10) Pub. No.: US 2012/0167705 A1
(43) Pub. Date: Jul. 5, 2012

(54) RELAY CONTROL OF A TRANSMISSION DIRECTION CONTROL SYSTEM

(75) Inventors: Simon Richard Conway, Warwickshire (GB); Richard George Smith, Cambridgeshire (GB); Edwin George Coombs, Leamington Spa (GB)

(73) Assignee: CATERPILLAR INC., Peoria, IL (US)

(21) Appl. No.: 13/126,796

(22) PCT Filed: Oct. 30, 2009
(86) PCT No.: PCT/US09/62791

§ 371 Date: Apr. 29, 2011

(30) Foreign Application Priority Data
Oct. 30, 2008 (EP) 08167968.0

(51) Int. Cl. F16H 59/02

(52) U.S. Cl. 74/473.12

(57) ABSTRACT

A transmission direction control system of a vehicle comprises a transmission circuit having a transmission actuator to activate a corresponding solenoid, and an actuating switch for controlling an electrical flow through the transmission circuit; a control circuit configured to actuate the switch; and a control configured for electrical communication with the transmission actuator and the control circuit to alternately activate the transmission circuit and the control circuit.

### TECHNICAL FIELD

This patent disclosure relates generally to a transmission direction control system and a related method of controlling the transmission direction control system for a vehicle, in particular for back hoe loaders.

### BACKGROUND

This patent disclosure relates generally to the field of transmission systems for construction vehicles, such as back hoe loaders. Back hoe loaders may fulfil a variety of different tasks at a construction site. The transmission systems used for this kind of vehicle may either be mechanically or hydraulically operated. The present disclosure may be mainly directed to a hydraulic system, where the transmission may be operated by actuation of solenoid valves.

The transmission system may usually have three operational modes, a forward direction mode, a reverse direction mode and a neutral position. The forward and reverse direction modes may be used to move the vehicle at the operation sites, the neutral mode may be used when stopping or parking the vehicle.

Such vehicles may be very heavy and it may be important to prevent the vehicle from moving due to unforeseen circumstances, such as electrical failures. Known systems for a transmission direction control system may have “single-side” control of the transmission solenoid valves. In such systems, only one side of the solenoid valves may be switched and the other side may be either directly connected to a power source or to the ground terminal.

Unfortunately, if a short-circuit occurs, the solenoid valve may be accidentally activated and the vehicle may start to move unintentionally. The short-circuit may occur by bridging the switching device at either the plus or the minus terminals, depending which terminal may be activating the solenoid valve. In order to prevent an uncommanded movement of such vehicle, a system using double sided switching is used, where the switch may interrupt the power supply on both sides of the solenoid valve, i.e. at the positive and negative terminal of the valve. In this manner, if an unforeseen connection between the power source and the ground terminal occurs, the solenoid valves may not be actuated.

In a vehicle with a lever for moving the vehicle into the moving and parking positions, the lever may be connected to a switching circuit. The switching circuit may either activate one or more solenoid valves or may leave the valves inactivated.

When a single point failure occurs in the foregoing system, the valves may be activated due to a contact of the input terminals to the power source, which may result in an unwanted movement of the vehicle. In order to prevent this, known vehicles may have a system that may disconnect the power source and the ground terminal when the vehicle is in the idle position or parking position. Such double sided switching interruption may provide a certain enhancement in convenience, but it may involve the use of additional switches and cabling when applied to a standard single side controlled vehicle.

Therefore, there may be a desire to apply a single sided control of a transmission direction control system without compromising the systems ability to tolerate single point electrical failures, i.e. one that does not engage forward or reverse movements of the vehicle in the event of a short circuit.

It is thus seen that there is a need for an advanced control of a transmission direction control system, which is cost-effective, easy to maintain and applicable to a large variety of vehicles.

### SUMMARY OF THE DISCLOSURE

In a first aspect, the present disclosure describes a transmission direction control system of a vehicle, comprising: a transmission circuit having a transmission actuator to activate a corresponding solenoid and an actuating switch for controlling an electrical flow through the transmission circuit; a control circuit configured to actuate said switch; and a control configured for electrical communication with the transmission actuator and the control circuit to alternately activate the transmission circuit and the control circuit.

In a second aspect, the present disclosure describes a method of controlling a transmission direction comprising: actuating a control configured for electrical communication with a transmission circuit and a control circuit, the transmission circuit including a transmission actuator to activate a corresponding solenoid and an actuating switch, the control circuit being configured to actuate the switch, wherein actuation of the control alternately activates the transmission circuit and the control circuit for controlling an electrical flow through the transmission circuit.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is a circuit diagram of a transmission direction control system engaged in a neutral configuration according to the present disclosure;

FIG. 2 is a circuit diagram of the transmission direction control system in a forward configuration according to the present disclosure;

FIG. 3 is a isometric view of a lever control for the transmission direction control system according to the present disclosure.

### DETAILED DESCRIPTION

This disclosure generally relates to a transmission direction control system for a vehicle. In one embodiment, it relates to a relay arrangement interrupting the transmission circuit of a vehicle.

In another embodiment, it relates to a method for interrupting a transmission direction control system using a relay.

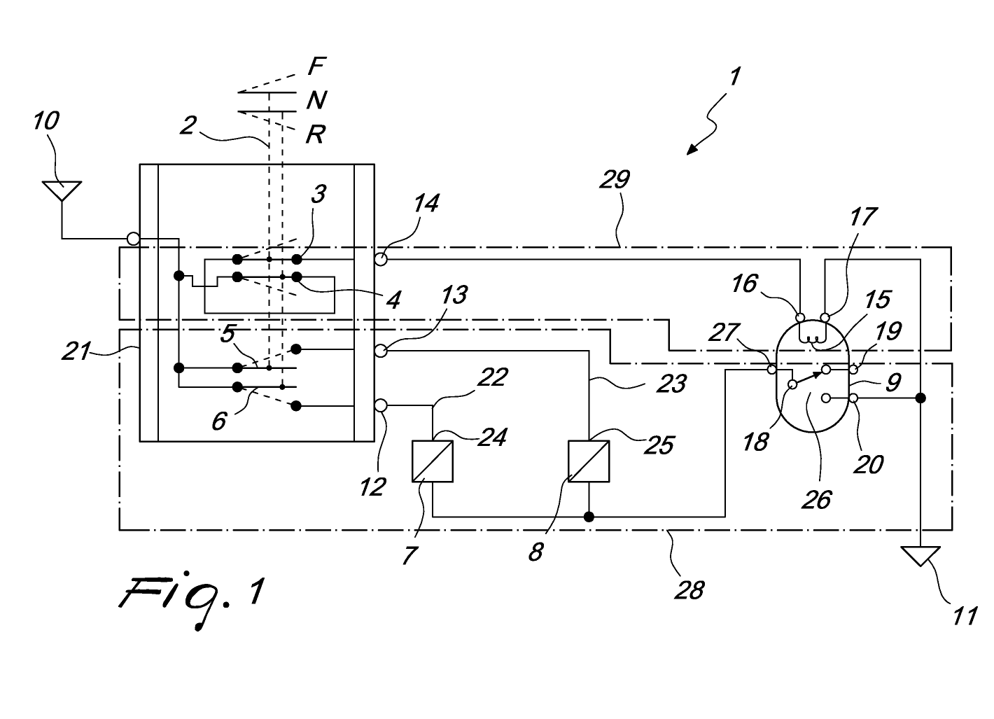

FIG. 1 illustrates a preferred embodiment of the transmission direction control system 1. Control system 1 may have transmission circuit 28 and a control circuit 29. Control system 1 may have relay actuators 3, 4 and transmission actuators 5, 6. The actuators may be located in a housing 21 and may be commonly connected to a control 2, such as a lever. The lever 2 may have three positions, a neutral position for idling or parking the vehicle, a forward position for moving the vehicle in the forward position, and a reverse position for moving the vehicle in a reverse direction.

Transmission actuators 5, 6 may be connected to solenoid valves 7, 8, which may actuate a further transmission. Actuators 5 and 6 may be arranged in parallel within transmission circuit 28. Actuator 5 may be connected to a solenoid valve 8, which may be responsible for the forward direction of the transmission system. Actuator 6 may be connected to a solenoid valve 7, which may be responsible for the reverse direction. Actuator 5 may be connected to a first output terminal 13 of a housing 21.

Terminal 13 may be connected via a first connection element 23 to an input terminal 25 of the forward solenoid valve 8. Actuator 6 may be connected to a second output terminal 14 of a housing 21. The terminal 14 may be connected via a second connection element 22 to an input terminal 24 of the reverse solenoid valve 7. When both the actuators 5, 6 are not actuated the transmission circuit 28 may be open and control system 1 may be in a neutral configuration. In the neutral configuration the vehicle may be in an idle mode, or parking mode.

The output terminals of the solenoid valves 7, 8 may be connected to a input terminal 18 through input terminal 27 of the relay 9. The input terminal 18 may be the central contact of a relay switch 26.

The relay switch 26 may connect to a second output terminal 20, which may be connected with the ground terminal 11 in a first state. The relay switch 26 may connect to an output terminal 19, which may not have an electrical contact, in a second state. In the second state there may be an open transmission circuit 28. The relay switch 26 may be activated by a relay coil 15, such as a magnetic coil of the relay 9.

Relay actuators 3, 4 may be connected between the power source 10 and the relay 9. The actuators 3, 4 may be arranged in series, or daisy-chained configuration. The relay actuators 3, 4 are mutually connected to the lever 2 together with the transmission actuator 5, 6 and may be located in the same housing 21.

A third output terminal 14 may be connected to an input terminal 16 of the relay coil 15 of the relay 9. The output terminal 17 of the relay coil 15 may be connected to the ground terminal 11. In an idle mode, the transmission direction control system 1 may be in a neutral configuration where the transmission actuators 5, 6 may not be in contact with the corresponding solenoid valves 7, 8 and the relay actuators 3, 4 may be in the normally-closed position. The normally-closed position of the relay actuators 3, 4 may energize the relay coil 15 so that the relay switch 26 may be actuated into the second state, where transmission circuit 28 is open, by connecting to the first output terminal 19.

Movement of the lever 2 into either the forward or the reverse direction may cause either one of the actuators 3, 4 to an open position and thereby interrupt the connection from the power source 10 to the input terminal 16 of the relay coil 15, which may result in de-energizing of the relay coil 15. The magnetic force of the relay coil 15 may be lost and the contact of the relay switch 26 may move to the first state and connect to relay output terminal 20 which may be connected to ground terminal 11.

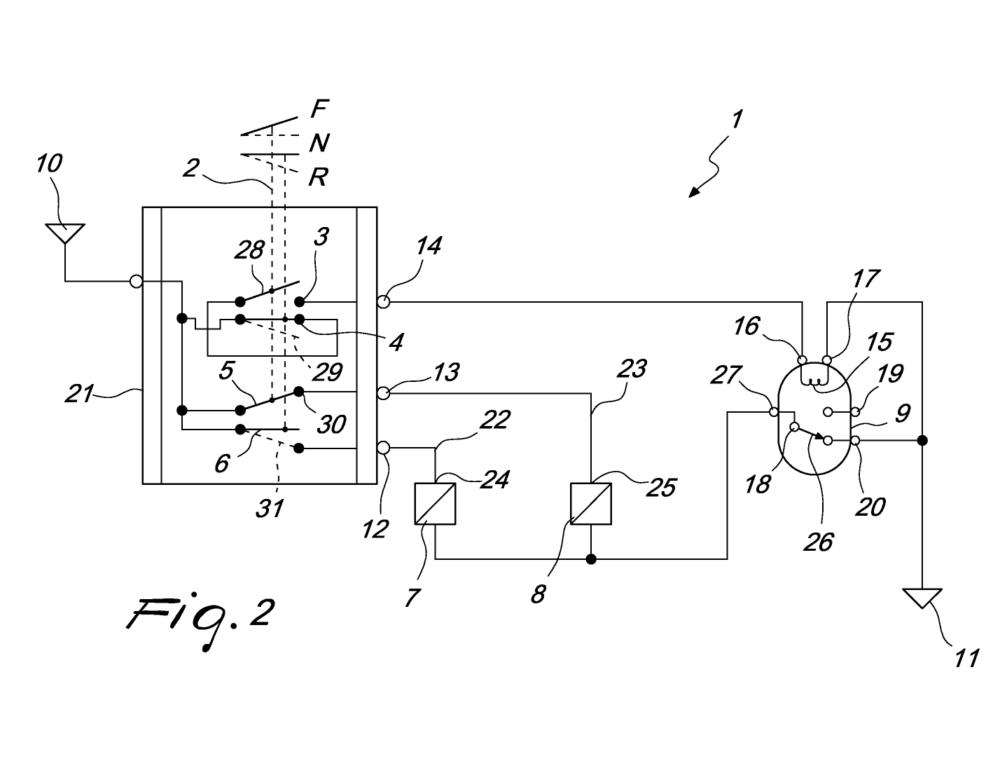

With reference to FIG. 2, lever 2 may be engaged to the forward position for moving the vehicle in a forward direction. The transmission direction control system 1 may be in a forward configuration where the relay actuator 3 may move to an open position and the transmission actuator 5 may move to contact with the output terminal 13.

With relay actuator 3 in the open position connection between the power source 10 and the input terminal of the relay coil 15 may be interrupted which may de-energize the relay coil 15. The magnetic force of the relay coil 15 may be lost and the contact of the relay switch 26 may move to contact output terminal 20, in the first state, which may be connected to ground terminal 11.

With transmission actuator 5 in contact with output terminal 13 and relay switch 26 in contact with output terminal 20 an electrical connection between power source 10 and the forward solenoid valve 8 may be established.

Lever 2 may be engaged to the reverse position for moving the vehicle in a reverse direction. The transmission direction control system 1 may be in a reverse configuration where the relay actuator 4 may move to an open position and the transmission actuator 6 may move to contact with the output terminal 12.

With relay actuator 4 in the open position connection between the power source 10 and the input terminal of the relay coil 15 may be interrupted which may de-energize the relay coil 15. The magnetic force of the relay coil 15 may be lost and the contact of the relay switch 26 may move to contact output terminal 20, in the first state, which may be connected to ground terminal 11.

With transmission actuator 6 in contact with output terminal 12 and relay switch 26 in contact with output terminal 20 an electrical connection between power source 10 and the reverse solenoid valve 7 may be established.

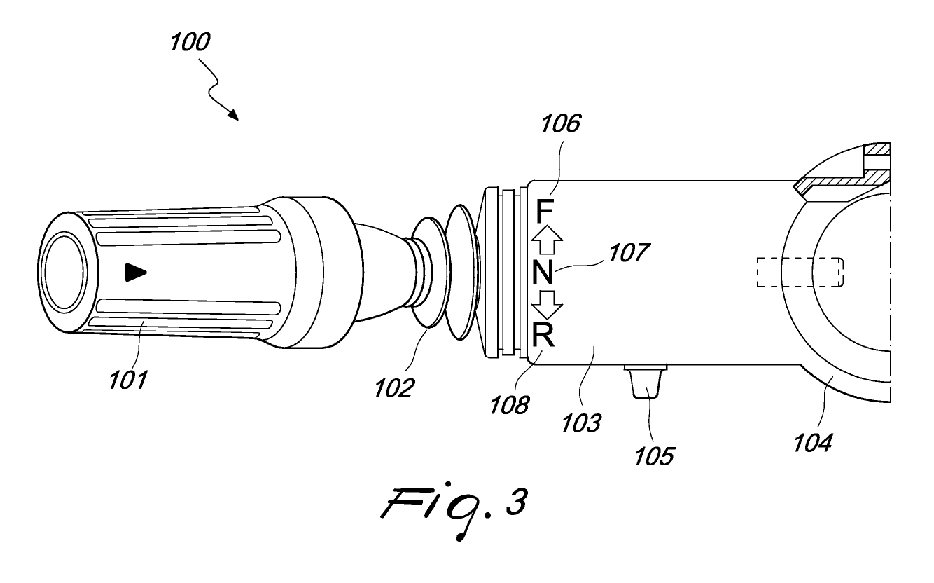

FIG. 3 illustrates a lever control 100, which may be an embodiment of lever 2. Lever control 100 for the transmission direction control system 1. Lever control 100 may comprise an input portion 101, a connection portion 102 and a housing portion 104. Lever control 100 may enable an operator of a vehicle to operate the transmission direction control system 1.

Input portion 101 may be shifted to one of three positions, for instance a forward position, a neutral position and a reverse position. The connection portion 102 connects input portion 101 to the housing portion 103. The connection portion 102 may be arranged to permit movement of the input portion 101 relative to the housing portion 103.

Housing portion 103 may include a switch 105 for activating the transmission direction control system 1 and a mounting member 104 for mounting the lever control 100 at a suitable location, for instance on a control panel in a cab of a vehicle. Housing portion 103 may bear markings 106, 107 and 108 to indicate the forward position, the neutral position and the reverse position respectively.

### INDUSTRIAL APPLICABILITY

This disclosure describes a relay control of a transmission direction control system, wherein the relay is arranged in between the lever switch and the ground terminal of a power supply. The relay is adapted to disconnect one of more solenoid valves from the ground terminal when the lever is switched into a neutral position, the neutral position being defined as a position where the vehicle is not moving.

The industrial applicability of the relay control of a transmission direction control system as either part of a transmission system or as an add-on element for existing transmission systems as described herein will be readily appreciated from the foregoing discussion. It is further seen that the relay control of a transmission direction control system arrangement provides for efficient operation of the vehicle. In case a short-circuit occurs, the relay disconnects the transmission direction control solenoid valves so that they may not be activated thereby preventing uncommanded movement of the vehicle. Furthermore the system may allow for efficient maintenance, for instance the relay may be replaced easily. Furthermore, such a system keeps the maintenance low and downtime of the machine to a minimum.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein.

Where reference signs follow technical features mentioned in any claim, the reference signs have been included for the sole purpose of increasing the intelligibility of the claims. Neither the reference signs nor their absence have any limiting effect on the technical features as described above or on the scope of any claim elements.

One skilled in the art will realize the invention may be embodied in other specific forms without departing from the invention or essential characteristics thereof.

The foregoing embodiments are therefore to be considered in all respects illustrative rather than limiting of the invention described herein. The scope of the invention is thus indicated by the appended claims, rather than by the foregoing description. Moreover, all changes that come within the meaning and range of equivalence of the claims are therefore intended to be embraced therein.

1. A transmission direction control system of a vehicle, comprising:
a transmission circuit having a transmission actuator to activate a corresponding solenoid, and
an actuating switch for controlling an electrical flow through the transmission circuit;
a control circuit configured to actuate said switch; and
a control configured for electrical communication with the transmission actuator and the control circuit to alternately activate the transmission circuit and the control circuit.

2. The control system of claim 1, wherein the transmission circuit comprises at least two transmission actuators arranged in parallel to selectively activate corresponding solenoids.

3. The control system of claim 2, wherein the transmission circuit and the control circuit are arranged in parallel.

4. The control system of claim 3, wherein the control circuit comprises at least two relay actuators arranged in series for controlling an electrical flow through the control circuit.

5. The control system any of claim 4, wherein the control circuit comprises a relay coil for actuating switch.

6. The control system of claim 5, wherein operation of the relay coil moves the switch between a first state and a second state.

7. The control system of any of claim 6, wherein the control is a lever.

8. The control system of claim 6, wherein the lever is coupled to the relay actuators.

9. The control system of claim 8, wherein the lever (2) is actuatable to one of three transmission control positions.

10. The control system of claim 9, wherein said transmission control position comprises a forward position, a reverse position and a neutral position.

11. The control system of claim 10, wherein the transmission circuit is closed and the control circuit is open with the lever in the forward or reverse positions.

12. The control system of claim 10, wherein the transmission circuit is open and the control circuit is closed with the lever in the neutral position.

13. A method of controlling a transmission direction comprising:
actuating a control configured for electrical communication with a transmission circuit and a control circuit, said transmission circuit including a transmission actuator to activate a corresponding solenoid and an actuating switch, said control circuit being configured to actuate the switch, wherein actuation of the control alternately activates the transmission circuit and the control circuit for controlling an electrical flow through the transmission circuit.

14. The method of claim 1, wherein the control is actuatable to one of three transmission control positions: a forward position, a reverse position and a neutral position.

15. The method of claim 14 comprising the step of closing the transmission circuit when the control is in the forward or reverse positions and opening the transmission circuit when the control is in the neutral position.
